(19) United States
(12) Patent Application Publication
(10) Pub. No.: US 2013/0263661 A1
(43) Pub. Date: Oct. 10, 2013

(54) PHYSICAL QUANTITY DETECTION DEVICE, PHYSICAL QUANTITY DETECTOR, ELECTRONIC APPARATUS, AND MANUFACTURING METHOD OF PHYSICAL QUANTITY DETECTION DEVICE

(71) Applicant: SEIKO EPSON CORPORATION, Tokyo (JP)

(72) Inventor: Jun WATANABE, Matsumoto-shi (JP)

(73) Assignee: SEIKO EPSON CORPORATION, Tokyo (JP)

(21) Appl. No.: 13/850,653

(22) Filed: Mar. 26, 2013

(30) Foreign Application Priority Data
Apr. 4, 2012 (JP) 2012-085865

(51) Int. Cl. G01P 1/02

(52) U.S. Cl. CPC G01P 1/023
USPC 73/504.12; 29/428

(57) ABSTRACT

A physical quantity detection device includes a base; a movable body that is supported by the base, and is displaced depending on a physical quantity; a physical quantity detection element that is laid between the base and the movable body; a support unit that is provided on at least one side of both main surfaces of the movable body; and a mass body that includes a first opening part, and is supported by the support unit in such a way that an inside of the first opening part is filled with the support unit.

### BACKGROUND

1. Technical Field

The present invention relates to a physical quantity detection device, a physical quantity detector, an electronic apparatus, and a manufacturing method of a physical quantity detection device.

2. Related Art

From the related art, a physical quantity detection device (for example, an acceleration sensor) which uses a physical quantity detection element, such as an oscillator or the like, has been known. Such a physical quantity detection device is configured to detect power which is applied to the physical quantity detection device based on change in a resonance frequency when power operates in a detection axis direction and the resonance frequency of a physical quantity detection element changes.

The physical quantity detection device includes a weight (hereinafter, referred to as a “mass body”) in order to receive acceleration which is applied to the device, generates distortion on beam which is formed on a crystal plate or the like due to the acceleration received by the weight, detects the amount of distortion or a resonance frequency using a detection unit which is provided in the beam, and thus it is possible to detect applied acceleration.

For example, JP-A-2008-309731 discloses a physical quantity detection device in which a mass body formed of metal is formed on a semiconductor wafer as a weight (mass body) using an electroless plating method.

However, in the device disclosed in JP-A-2008-309731, it is necessary to provide an additional electroless plating process in order to form the mass body, and thus a manufacturing process is complicated and the rise of manufacturing cost is brought. In addition, the thickness of a film which is formed based on a film formation condition of the electroless plating is limited, and it is necessary to cause a larger number of regions on the crystal plate to be mass-body forming regions in order to provide a mass body which has heavier mass, and thus it is difficult to meet the needs of reduction in a device size.

As simpler means, it may be taken into consideration that the mass body is supported using adhesive formed of thermosetting resin. According to this, even when a heavier mass body is provided, it is possible to support the mass body in a predetermined bonding region. However, when the mass body is supported using the adhesive, there is a possibility that bonding reliability is lowered, compared to a metallic film which is formed using the electroless plating.

From the above, a physical quantity detection device is needed which can support the mass body through a support unit formed of adhesive, and which further improves the bonding reliability of the mass body.

### SUMMARY

An advantage of some aspects of the invention is to provide a physical quantity detection device and a manufacturing method thereof, which can support a mass body through a support unit formed of adhesive, and which improves the bonding reliability of the mass body. Another advantage of some aspects of the invention is to provide a physical quantity detector and an electronic apparatus which include the physical quantity detection device.

The invention can be implemented as the following forms or application examples.

### APPLICATION EXAMPLE 1

This application example is directed to a physical quantity detection device including: a base; a movable body that is supported by the base, and is displaced depending on a physical quantity; a physical quantity detection element that is laid between the base and the movable body; a support unit that is arranged above at least one side of both main surfaces of the movable body; and a mass body that includes a first opening part, and is supported by the support unit in such a way that an inside of the first opening part is filled with the support unit.

According to the physical quantity detection device, the mass body includes the first opening part, the inside of the first opening part is filled with the support unit, and thus the mass body is supported by the support unit. According to this, compared to a case in which the mass body does not include the first opening part and the support unit only comes into contact with the surface of the mass body, the contact area between the support unit and the mass body can be increased. Therefore, the physical quantity detection device which improves the bonding reliability of the mass body can be provided.

### APPLICATION EXAMPLE 2

In the physical quantity detection device according to the application example, the support unit may be provided to be extended to a circumference of an opening of the first opening part of the mass body.

According to this physical quantity detection device, the contact area between the support unit and the mass body can be further increased. Therefore, the physical quantity detection device which improves the bonding reliability of the mass body can be provided.

### APPLICATION EXAMPLE 3

In the physical quantity detection device according to the application example, the first opening part may include: a first section that has a first internal diameter; and a second section that is further separated from the movable body than the first section, continues on the first section, and has a second internal diameter which is greater than the first internal diameter.

According to this physical quantity detection device, the contact area between the support unit and the mass body can be further increased. In addition, sine stepped surfaces are formed on the inner wall surface of the first opening part, anchor effect can be generated between the support unit and the mass body. Therefore, the physical quantity detection device which improves the bonding reliability of the mass body can be provided.

### APPLICATION EXAMPLE 4

In the physical quantity detection device according to the application example, the first opening part may include a taper-shaped inner wall surface.

According to this physical quantity detection device, the contact area between the support unit and the mass body can be further increased. Therefore, the physical quantity detection device which improves the bonding reliability of the mass body can be provided.

### APPLICATION EXAMPLE 5

In the physical quantity detection device according to the application example, the first opening part may be a through-hole which communicates with a second opening.

According to this physical quantity detection device, the contact area between the support unit and the mass body can be further increased. Therefore, the physical quantity detection device which improves the bonding reliability of the mass body can be provided.

### APPLICATION EXAMPLE 6

In the physical quantity detection device according to the application example, the support unit may be provided to be extended to the circumference of the second opening.

According to the physical quantity detection device, the contact area between the support unit and the mass body can be further increased. In addition, since the support unit is provided to be extended to the circumference of the second opening, anchor effect can be generated between the support unit and the mass body. Therefore, the physical quantity detection device which improves the bonding reliability of the mass body can be provided.

### APPLICATION EXAMPLE 7

In the physical quantity detection device according to the application example, an inner wall surface of the first opening part of the mass body may be a rough surface.

According to this physical quantity detection device, the contact area between the support unit and the mass body can be further increased. Therefore, the physical quantity detection device which improves the bonding reliability of the mass body can be provided.

### APPLICATION EXAMPLE 8

This application example is directed to a manufacturing method of a physical quantity detection device including: preparing a base and a movable body that is supported by the base and is displaced depending on a physical quantity; providing a physical quantity detection element that is laid between the base and the movable body; preparing a mass body that includes a first opening part; in a state in which insides of the first opening part are filled with a support unit, supporting the mass body by the movable body through the support unit in such a way that an opening of the first opening part on at least one side of both main surfaces of the movable body face to another.

The manufacturing method of a physical quantity detection device includes forming the support unit which is provided on at least one of both the main surfaces of the movable body, and which supports the mass body by filling the inside of the first opening part. According to this, the physical quantity detection device which improves the bonding reliability of the mass body can be simply provided.

### APPLICATION EXAMPLE 9

In the manufacturing method of a physical quantity detection device according to the application example, the forming of the support unit may include: arranging a first adhesive in the first opening part of the mass body; arranging a second adhesive in at least one side of the both main surfaces of the movable body; and forming the support unit by performing a thermal process after bonding the first adhesive to the second adhesive.

According to this manufacturing method of a physical quantity detection device, the inside of the first opening part can be reliably filled with the first adhesive. Therefore, the physical quantity detection device which improves the bonding reliability of the mass body can be provided.

### APPLICATION EXAMPLE 10

In the manufacturing method of a physical quantity detection device according to the application example, the first opening part of the mass body may be a through-hole which communicates with the second opening, and the forming of the support unit may include: mounting the mass body on at least one side of both the main surfaces of the movable body through a spacer such that the second opening faces an outside and the first opening part faces a side of the movable body; and injecting adhesive from a side of the second opening, filling the through-hole of the mass body with the adhesive, and forming the support unit that supports the mass body by performing the thermal process.

The manufacturing method of a physical quantity detection device includes mounting the mass body through the spacer, injecting the adhesive from the side of the second opening and filling the through-hole of the mass body with the adhesive, and forming the supporting unit which supports the mass body by performing the thermal process. According to this, the interval between the mass body and the movable body can be simply adjusted by adjusting only the thickness of the spacer. In addition, the inside of the through-hole can be filled with the support unit using a simple method. Therefore, the physical quantity detection device which improves the bonding reliability of the mass body can be provided using the simple method.

### APPLICATION EXAMPLE 11

In the physical quantity detection device according to the application example, the physical quantity detection element may be a twin-tuning fork vibrating element.

### APPLICATION EXAMPLE 12

This application example is directed to a physical quantity detector including: the physical quantity detection device according to the application example; and a package that contains the physical quantity detection device.

According to this physical quantity detector, since the physical quantity detection device which improves the bonding reliability of the mass body is included, the physical quantity detector which improves reliability can be provided.

### APPLICATION EXAMPLE 13

This application example is directed to an electronic apparatus including the physical quantity detection device according to the application example.

According to this electronic apparatus, since the physical quantity detection device which improves the bonding reliability of the mass body is included, the electronic apparatus which improves reliability can be provided.

### BRIEF DESCRIPTION OF THE DRAWINGS

The invention will be described with reference to the accompanying drawings, wherein like numbers reference like elements.

FIG. 1 is a plane view schematically illustrating a physical quantity detection device according to an embodiment.

FIG. 2 is a cross-sectional view schematically illustrating the physical quantity detection device according to the embodiment.

FIG. 3 is a cross-sectional view illustrating the operation of the physical quantity detection device according to the embodiment.

FIG. 4 is a cross-sectional view illustrating the operation of the physical quantity detection device according to the embodiment.

FIG. 5 is a cross-sectional view schematically illustrating a first modification example of the physical quantity detection device according to the embodiment.

FIG. 6 is a cross-sectional view schematically illustrating a second modification example of the physical quantity detection device according to the embodiment.

FIG. 7 is a cross-sectional view schematically illustrating a third modification example of the physical quantity detection device according to the embodiment.

FIG. 8 is a cross-sectional view schematically illustrating a fourth modification example of the physical quantity detection device according to the embodiment.

FIG. 9 is a cross-sectional view schematically illustrating a fifth modification example of the physical quantity detection device according to the embodiment.

FIG. 10 is a flowchart illustrating a manufacturing method of the physical quantity detection device according to the embodiment.

FIG. 11 is a flowchart illustrating the manufacturing method of the physical quantity detection device according to the embodiment.

FIG. 12 is a flowchart illustrating the manufacturing method of the physical quantity detection device according to the embodiment.

FIGS. 13A and 13B are cross-sectional views schematically illustrating the manufacturing method of the physical quantity detection device according to the embodiment.

FIGS. 14A to 14D are cross-sectional views schematically illustrating the manufacturing method of the physical quantity detection device according to the embodiment.

FIGS. 15A to 15D are cross-sectional views schematically illustrating the manufacturing method of the physical quantity detection device according to the embodiment.

FIG. 16 is a plane view schematically illustrating a physical quantity detector according to the embodiment.

FIG. 17 is a cross-sectional view schematically illustrating a physical quantity detector according to the embodiment.

FIG. 18 is a perspective view schematically illustrating an electronic apparatus according to the embodiment.

### DESCRIPTION OF EXEMPLARY EMBODIMENTS

Hereinafter, a preferable embodiment of the invention will be described in detail with reference to the accompanying drawings. Meanwhile, the embodiment which is described hereinafter is not unfairly limit the content of the invention which is disclosed in the appended claims. In addition, all of the configurations which are described hereinafter are not limited as the essential constitution conditions of the invention.

### 1. PHYSICAL QUANTITY DETECTION DEVICE

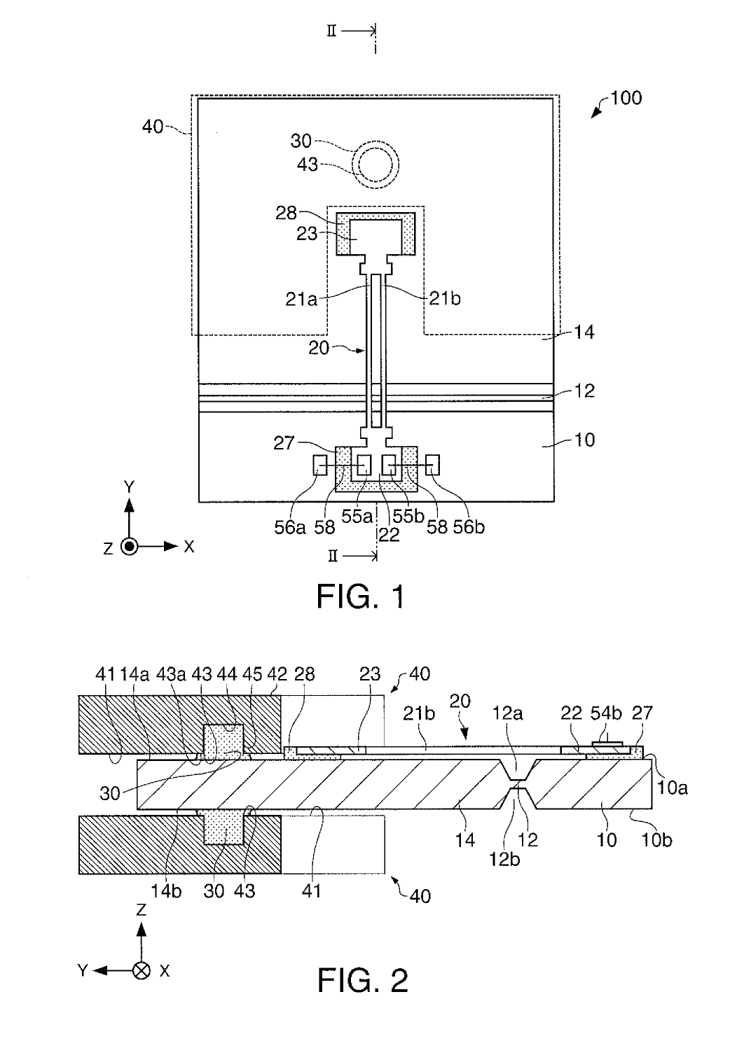

First, a physical quantity detection device according to an embodiment will be described with reference to the accompanying drawings. FIG. 1 is a plane view schematically illustrating a physical quantity detection device 100 according to the embodiment. FIG. 2 is a cross-sectional view schematically illustrating the physical quantity detection device 100 according to the embodiment, and is a cross-sectional view taken along line II-II of FIG. 1. Meanwhile, in FIG. 1, for convenience, a mass body 40 is seen through and shown. In addition, in FIGS. 1 and 2, as three axes which are at right angles to one another, an X axis, a Y axis, and a Z axis are shown.

The physical quantity detection device 100 includes a base 10, a coupling part 12, a movable body 14, and a physical quantity detection element 20, as shown in FIGS. 1 and 2. The physical quantity detection device 100 can further include a mass body 40, and a support unit 30 which supports the mass body 40.

The base 10 supports the movable body 14 through the coupling part 12. The coupling part 12 is provided between the base 10 and the movable body 14, and is connected to the base 10 and the movable body 14. The thickness of the coupling part 12 is less than the thickness of the base 10 and the thickness of the movable body 14. For example, it is possible to form the coupling part 12 by forming recessed parts 12a and 12b (refer to FIG. 2) from the sides of both main surfaces 10a and 10b of a crystal substrate by performing half etching. In an example shown in the drawing, the recessed parts 12a and 12b are formed along the X axis. When the movable body 14 is displaced (rotationally moves) with regard to the base 10, the coupling part 12 becomes a fulcrum, and can be a rotation axis along the X axis. That is, the coupling part 12 can be the base point of the movable body 14 and the deflecting portion of a cantilever which is configured with the coupling part 12.

The movable body 14 is provided on the base 10 through the coupling part 12. In the example shown in the drawing, the movable body 14 is extended along the Y axis (in the +Y axis direction) from the base 10 through the coupling part 12. The movable body 14 is a plate shape. The movable body 14 can displace the coupling part 12 as a fulcrum (rotation axis) in a direction (Z axis direction) which intersects main surfaces 14a and 14b depending on acceleration added in the direction (Z axis direction) which intersects the main surfaces 14a and 14b.

The base 10, the coupling part 12, and the movable body 14 are integrally formed by, for example, patterning a crystal substrate which is quarried at a predetermined angle from the raw stone of crystal using a photolithography technology or an etching technology. Meanwhile, materials of the base 10, the coupling part 12, and the movable body 14 are not limited to the crystal, and a semiconductor material, such as glass or silicon, may be used.

The physical quantity detection element 20 is laid between the base 10 and the movable body 14. In the example shown in the drawing, the first base portion 22 of the physical quantity detection element 20 is arranged above the main surface 10a of the base 10, and the second base portion 23 of the physical quantity detection element 20 is arranged above the main surface 14a of the movable body 14. The base 10 is bonded to the first base portion 22 through a bonding member (first bonding member) 27, and the movable body 14 is bonded to the second base portion 23 through a bonding member (second bonding member) 28. Therefore, the physical quantity detection element 20 is provided on the upper side of the base 10, the coupling part 12, and the movable body 14 through a space. Meanwhile, although not shown in the drawing, the physical quantity detection element 20 may be directly bonded to the base 10 and the movable body 14.

The physical quantity detection element 20 includes vibrating beam parts 21a and 21b, the first base portion 22, and the second base portion 23. For example, when the movable body 14 is displaced, force is generated in the vibrating beam parts 21a and 21b, and information about the detection of a physical quantity which is generated in the vibrating beam parts 21a and 21b changes.

The vibrating beam parts 21a and 21b are extended from the first base portion 22 to the second base portion 23 along the extension direction of the movable body 14 (along the Y axis). The shapes of the vibrating beam parts 21a and 21b are, for example, prism shapes. When a driving signal (alternation voltage) is applied to excitation electrodes (not shown) which is provided in the vibrating beam parts 21a and 21b, the vibrating beam parts 21a and 21b can perform bending vibration such that the vibrating beam parts 21a and 21b are separated from each other or approach each other along the X axis.

The first and the second base portions 22 and 23 are connected to both ends of the vibrating beam parts 21a and 21b. The first base portion 22 is fixed to the base 10 through the bonding member 27. The first base portion 22 may cover the bottom surface and the side surface using the bonding member 27. In addition, the second base portion 23 is fixed to the movable body 14 through the bonding member 28. The second base portion 23 may cover the bottom surface and the side surface using the bonding member 28. For example, low melting point glass, Au/Sn alloy coat which can be used for eutectic bonding, thermoset resin such as silicone series resin can be used as the bonding members 27 and 28.

Meanwhile, predetermined gaps are provided between the vibrating beam parts 21a and 21b, the base 10, and the movable body 14 such that the vibrating beam parts 21a and 21b, the base 10, and the movable body 14 do not come into contact with each other when the movable body 14 is displaced. These gaps may be managed using, for example, the thickness of the bonding members 27 and 28.

The physical quantity detection element 20 includes two vibrating beam parts 21a and 21b, a pair of base portions 22 and 23 as described above. That is, the physical quantity detection element 20 is a twin-tuning fork element (twin-tuning fork vibrating element). The physical quantity detection element 20 is formed by, for example, patterning a crystal substrate which is quarried at a predetermined angle from the raw stone of a crystal using a photolithography technology or an etching technology. Therefore, it is possible to integrally form the vibrating beam parts 21a and 21b and the base portions 22 and 23.

Meanwhile, the material of the physical quantity detection element 20 is not limited to the crystal, and may use a piezoelectric material, such as lithium tantalite (LiTaO₃), lithium tetraborate (Li₂B₄O₇), lithium niobate (LiNbO₃), lead zirconate titanate (PZT), Zinc Oxide (ZnO), aluminum nitride (AlN) or the like, or a semiconductor material such as a silicon which is provided in such a way to use a piezoelectric body, such as Zinc Oxide (ZnO), aluminum nitride (AlN), or the like, as a film. However, when the reduction in the difference in the linear expansion coefficients of the base 10 and the movable body 14 is taken into consideration, it is preferable that the material of the physical quantity detection element 20 be the same as the material of the base 10 and the movable body 14.

Extraction electrodes 55a and 55b are provided on the first base portion 22 of the physical quantity detection element 20. The extraction electrodes 55a and 55b are electrically connected to the excitation electrodes (not shown) which are provided in the vibrating beam parts 21a and 21b.

The extraction electrodes 55a and 55b are electrically connected to connection terminals 56a and 56b which are provided in the main surface 10a of the base 10 using, for example, a metal wire 58 formed of Au, Al, or the like. More specifically, the extraction electrode 55a is electrically connected to the connection terminal 56a, and the extraction electrode 55b is electrically connected to the connection terminal 56b. The connection terminals 56a and 56b are electrically connected to external connection terminals (not shown) using wiring (not shown).

For example, a laminated body, which uses a Cr layer as a ground and laminates an Au layer on the Cr layer, is used as the excitation electrodes, the extraction electrodes 55a and 55b, the connection terminals 56a and 56b, or the external connection terminals. The excitation electrodes, the extraction electrodes 55a and 55b, the connection terminals 56a and 56b, or the external connection terminal forms a conductive layer (not shown) using, for example, a sputter method, and forms the conductive layer by performing patterning.

The support unit 30 is a member which supports the mass body 40 on the movable body 14, and is provided on at least one side of both the main surfaces 14a and 14b of the movable body 14. The shape of the support unit 30 is not limited in particular unless it is not possible to support the mass body 40 with desired height (height from both the main surfaces 14a and 14b).

The material of the support unit 30 includes resin. Adhesive which is formed of a thermosetting resin material may be exemplified as the resin which is used as the material of the support unit 30. For example, it is possible to use the thermoset adhesive of a silicone series resin (modified silicone resin or the like) as the support unit 30. In addition, the support unit 30 may include well-known various types of metal particles (filer).

The mass body 40 is provided on the upper side of at least one side of both the main surfaces 14a and 14b of the movable body 14, as shown in FIG. 2. The mass body 40 includes a first surface 41 on the side of the movable body 14 and a second surface 42 on the opposite side thereof. In addition, as shown in FIG. 1, the mass body 40 is provided so as not to overlap with the physical quantity detection element 20 in planar view (when viewed from the Z axis direction). The mass body 40 may be formed such that the mass body 40 is not provided on the upper portion of the physical quantity detection element 20 in planar view. In addition, although not shown in the drawing, the mass body 40 may have a cuboid shape or a globular shape.

The mass body 40 includes a first opening part 43, and is supported by the support unit 30 in such a way that the inside of the first opening part 43 is filled with the support unit 30. Here, although it is preferable that the inside of the first opening part 43 be filled with only the support unit 30, air bubbles which are generated during a filling process may be included therein.

The first opening part 43 is provided in the first surface 41 which is the surface on the side of the movable body 14. The shape of the first opening part 43 is not particularly limited unless it is not a depressed portion provided in the first surface 41. In the example shown in the drawing, the shape of the first opening part 43 in planar view may be a circle.

The first opening part 43 may be a depressed portion which does not pass through the mass body 40, as shown in FIG. 2. In this case, the first opening part 43 may include a bottom surface 44 and a side surface 45. In addition, although not shown in the drawing, the bottom surface 44 and the side surface 45 may not have clear boundaries and may be a continuous curved surface.

The first opening part 43 may be formed using well-known grinding means. For example, the first opening part 43 may be formed using grinding means in which an inner wall surface is a rough surface. In other words, a surface roughening process may be performed on the inner wall surface of the first opening part 43. For example, the first opening part 43 maybe formed by a grinding tool, such as a sandblasting device or a drill. According to this, it is possible to make inner wall surfaces 44 and 45 be rougher surfaces than the surfaces of the mass body 40, and thus it is possible to further increase the contact area between the support unit 30 and the mass body 40.

For example, metal, such as Cu or Au, is exemplified as the material of the mass body 40. It is possible to improve the detection sensitivity of acceleration which is added to the physical quantity detection device 100 using the mass body 40.

Meanwhile, although not shown in the drawing, the number of mass bodies 40 is not limited, and, for example, a plurality of mass bodies may be provided to one of the main surfaces 14a and 14b of the movable body 14.

In addition, the support unit 30 may be provided to fill the first opening part 43, and be extended (covers) to the circumference 43a of the first opening part 43. According to this, it is possible to further increase the contact area between the support unit 30 and the mass body 40.

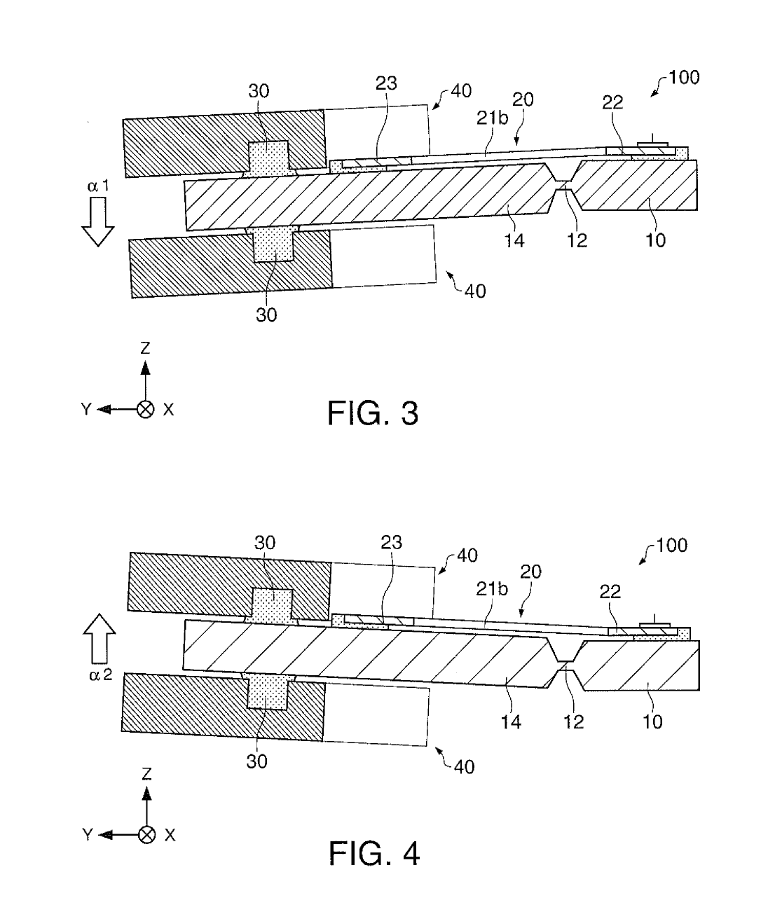

Subsequently, an operation of the physical quantity detection device 100 will be described. FIGS. 3 and 4 are cross-sectional views illustrating the operation of the physical quantity detection device 100.

As shown in FIG. 3, in the physical quantity detection device 100, if acceleration α1 (for example, gravity acceleration) is added in the −Z axis direction, the movable body 14 is displaced in the −Z axis direction depending on the acceleration α1 while the coupling part 12 is used as a fulcrum. Therefore, power (tension) in the direction in which the first base portion 22 and the second base portion 23 are separated from each other is added to the physical quantity detection element 20 along the Y axis, and thus tension stress is generated in the vibrating beam parts 21a and 21b. Therefore, the vibration frequencies (resonance frequencies) of the vibrating beam parts 21a and 21b become high.

On the other hand, as shown in FIG. 4, in the physical quantity detection device 100, if acceleration α2 is added in the +Z axis direction, the movable body 14 is displaced in the +Z axis direction depending on the acceleration α2 while the coupling part 12 is used as a fulcrum. Therefore, power (compression force) in the direction in which the first base portion 22 and the second base portion 23 approach each other is added to the physical quantity detection element 20 along the Y axis, and thus compression stress is generated in the vibrating beam parts 21a and 21b. Therefore, the vibration frequencies (resonance frequencies) of the vibrating beam parts 21a and 21b become high.

The physical quantity detection device 100 detects change in the resonance frequency of the physical quantity detection element 20 as described above. More specifically, the acceleration added to the physical quantity detection device 100 is deduced by converting the acceleration into a numerical value which is determined based on a look-up table or the like depending on the rate of change of the detected resonance frequency.

Meanwhile, when the physical quantity detection device 100 is used for an inclinometer, a direction in which gravity acceleration is added to the inclinometer changes depending on the change in the posture of inclination, and tension stress or compression stress is generated in the vibrating beam parts 21a and 21b. Further, the resonance frequencies of the vibrating beam parts 21a and 21b change.

In addition, an example in which so-called twin-tuning fork element is used as the physical quantity detection element 20 has been described in the above example. However, if it is possible to detect a physical quantity based on the displacement of the movable body 14, the form of the physical quantity detection element 20 is not particularly limited.

The physical quantity detection device 100 according to the embodiment has, for example, the following characteristics.

In the physical quantity detection device 100, the mass body 40 includes the first opening part 43, the first opening part 43 is filled with the support unit 30, and thus the mass body 40 is supported by the support unit 30. Therefore, since it is possible to increase the contact area between the mass body 40 and the support unit 30 without increasing the forming region of the support unit 30 and it is possible to generate anchor effect between the mass body 40 and the support unit 30, it is possible to improve the bonding reliability of the mass body 40.

In addition, in the physical quantity detection device 100, the support unit 30 is an elastic body which is formed of silicone series resin or the like, and the support unit 30 which is formed of the elastic body is provided to fill into the first opening part 43. According to this, since it is possible to relive or absorb excessive stress which is added when an operation is performed, it is possible to improve the bonding reliability of the mass body 40.

Hereinafter, modification examples of the physical quantity detection device 100 according to the embodiment will be described with reference to the drawings.

### 1.1 FIRST MODIFICATION EXAMPLE

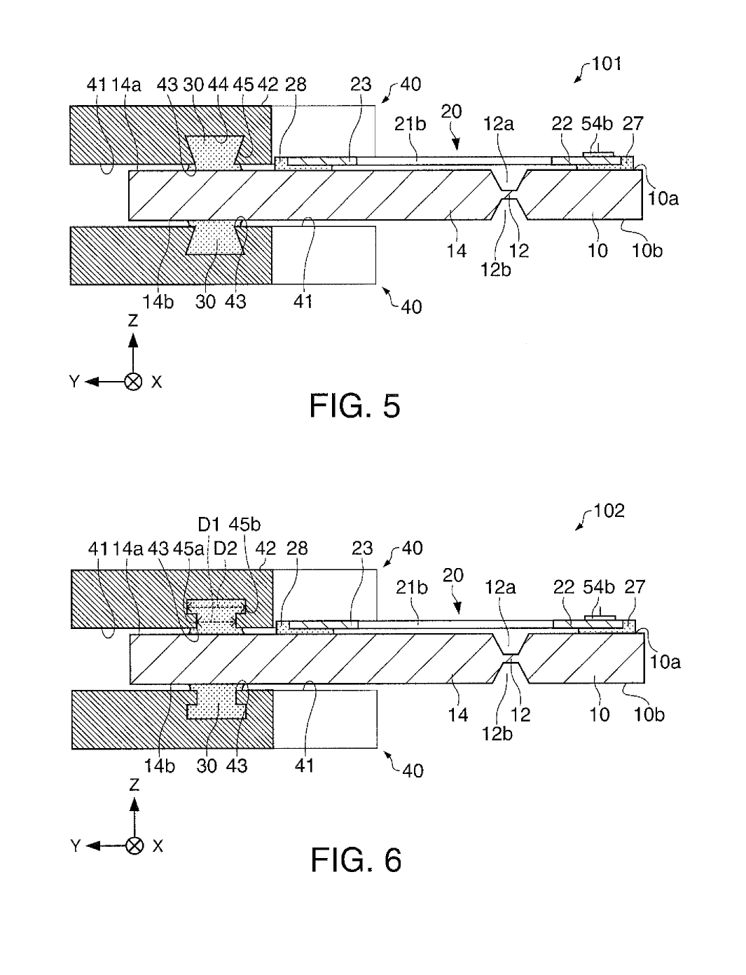

FIG. 5 is a cross-sectional view schematically illustrating a physical quantity detection device 101 according to a first modification example of the physical quantity detection device 100 according to the embodiment, and corresponds to the cross-sectional view taken along line II-II of FIG. 1.

In the physical quantity detection device 101, the first opening part 43 includes a taper-shaped inner wall surface. As shown in FIG. 5, the side surface 45 of the inner wall surface of the first opening part 43 of the mass body 40 may be a taper-shaped side surface. Here, as shown in the drawing, the side surface 45 is a taper surface in which an opening area broadens toward the side of a bottom surface 44. According to this, it is possible to further increase the contact area between the mass body 40 and the support unit 30, compared to the case in which the side surface 45 is not a taper surface like the physical quantity detection device 100. Therefore, it is possible to further improve the bonding reliability of the mass body 40.

### 1.2 SECOND MODIFICATION EXAMPLE

FIG. 6 is a cross-sectional view schematically illustrating a physical quantity detection device 102 according to a second modification example of the physical quantity detection device 100 according to the embodiment, and corresponds to the cross-sectional view taken along line II-II of FIG. 1.

In the physical quantity detection device 102, the first opening part 43 is on the side of the opening and includes a first section 45a which has a first internal diameter D1, and a second section 45b which continues on the first section 45a and has a second internal diameter D2 which is greater than the first internal diameter D1. That is, as shown in FIG. 6, stepped surfaces 45a and 45b are formed on the inner wall surface 45. According to this, it is possible to further increase the contact area between the mass body 40 and the support unit 30, compared to the physical quantity detection device 100. In addition, it is possible to generate further stronger anchor effect between the mass body 40 and the support unit 30. Therefore, it is possible to further improve the bonding reliability of the mass body 40.

### 1.3 THIRD MODIFICATION EXAMPLE

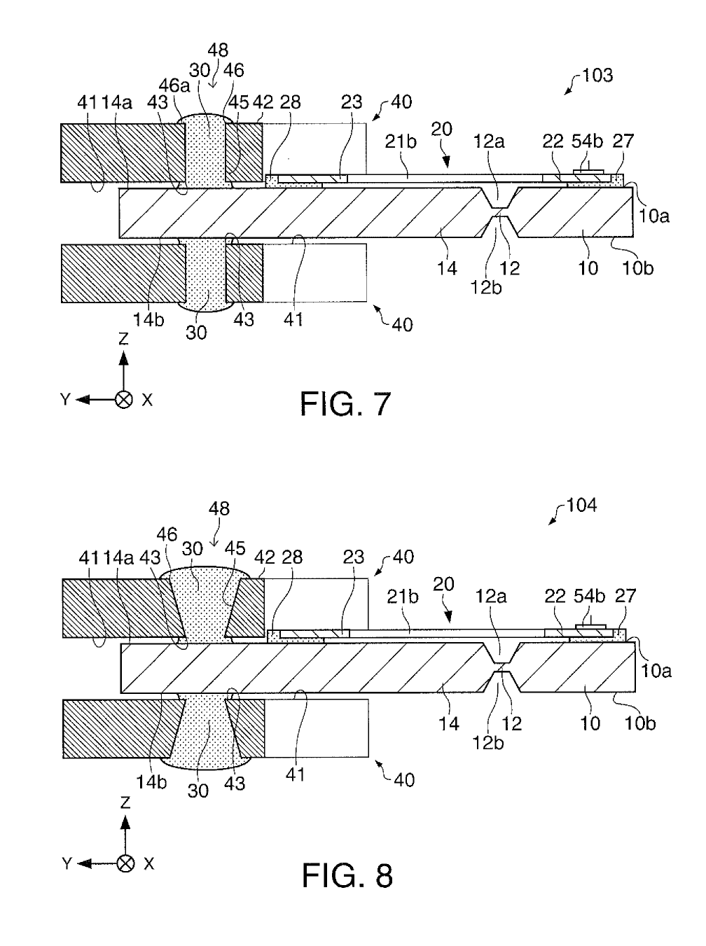

FIG. 7 is a cross-sectional view schematically illustrating a physical quantity detection device 103 according to a third modification example of the physical quantity detection device 100 according to the embodiment, and corresponds to the cross-sectional view taken along line II-II of FIG. 1.

In the mass body 40 of the physical quantity detection device 103, the first opening part 43 is a through-hole which communicates with a second opening 46, and the through-hole 48 is filled with the support unit 30. The second opening 46 is open in the second surface 42 of the mass body 40. The inner wall surface of the through-hole 48 includes only the side surface 45. According to the physical quantity detection device 103, it is possible to further increase the contact area between the mass body 40 and the support unit 30, compared to the physical quantity detection device 100.

In addition, as shown in the drawing, the support unit 30 may be provided such that the support unit 30 broadens to the circumference 46a of the second opening 46. According to this, it is possible to generate further stronger anchor effect between the mass body 40 and the support unit 30. Therefore, it is possible to further improve the bonding reliability of the mass body 40.

### 1.4 FOURTH MODIFICATION EXAMPLE

FIG. 8 is a cross-sectional view schematically illustrating a physical quantity detection device 104 according to a fourth modification example of the physical quantity detection device 100 according to the embodiment, and corresponds to the cross-sectional view taken along line II-II of FIG. 1. Meanwhile, the physical quantity detection device 104 is a modification example of the physical quantity detection device 103 which includes the through-hole 48.

As shown in FIG. 8, the inner wall surface 45 of the through-hole 48 may be a taper-shaped surface. Here, as shown in the drawing, the side surface 45 is a taper surface in which an opening area broadens toward the second surface 42 from the first surface 41. According to this, it is possible to further increase the contact area between the mass body 40 and the support unit 30, compared to the physical quantity detection device 103. Therefore, it is possible to further improve the bonding reliability of the mass body 40.

### 1.5 FIFTH MODIFICATION EXAMPLE

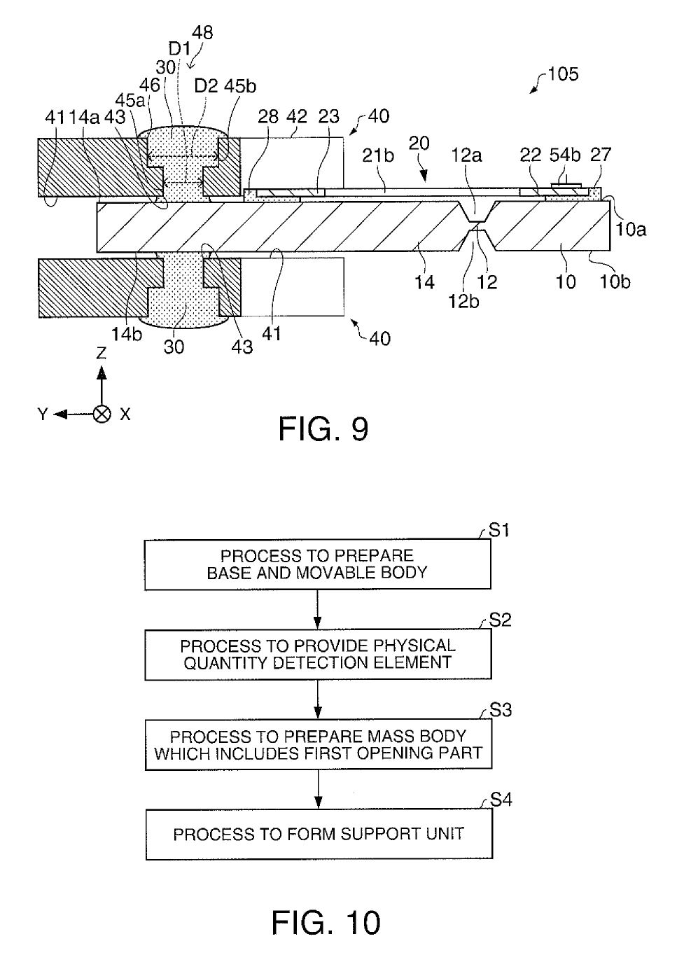

FIG. 9 is a cross-sectional view schematically illustrating a physical quantity detection device 105 according to a fifth modification example of the physical quantity detection device 100 according to the embodiment, and corresponds to the cross-sectional view taken along line II-II of FIG. 1. Meanwhile, the physical quantity detection device 105 is a modification example of the physical quantity detection device 103 which includes the through-hole 48.

In the physical quantity detection device 105, the through-hole 48 is on the side of the first opening part 43, and includes a first section 45a which has a first internal diameter D1, and a second section 45b which continues on the first section 45a and has a second internal diameter D2 which is greater than the first internal diameter D1. That is, as shown in FIG. 9, stepped surfaces 45a and 45b are formed on the inner wall surface 45. According to this, it is possible to further increase the contact area between the mass body 40 and the support unit 30, compared to the physical quantity detection device 103. In addition, it is possible to generate further stronger anchor effect between the mass body 40 and the support unit 30. Therefore, it is possible to further improve the bonding reliability of the mass body 40.

### 2. MANUFACTURING METHOD OF PHYSICAL QUANTITY DETECTION DEVICE

Subsequently, a manufacturing method of a physical quantity detection device according to the embodiment will be described with reference to the accompanying drawings. FIGS. 10 to 12 are flowcharts illustrating the manufacturing method of a physical quantity detection device according to the embodiment. FIGS. 13A to 15D are cross-sectional views schematically illustrating the manufacturing method of a physical quantity detection device according to the embodiment, and correspond to the cross-sectional views taken along lines II-II of FIG. 1.

As shown in FIG. 10, the manufacturing method of a physical quantity detection device according to the embodiment includes a process (S1) to prepare a base 10 and a movable body 14 which is provided on the base 10 through the coupling part 12 and is displaced depending on a physical quantity, a process (S2) to provide the physical quantity detection element 20 such that the physical quantity detection element 20 is laid between the base 10 and the movable body 14, a process (S3) to prepare the mass body 40 which includes the first opening part 43, and a process (S4) to form the support unit which is provided at least one of both the main surfaces of the movable body 14 and supports the mass body 40 in such a way that the first opening part 43 is filled with the support unit 14. However, the process (S2) to provide the physical quantity detection element may be performed after the process (S3) to prepare the mass body 40 and the process (S4) to form the support unit are performed, and process order is not limited.

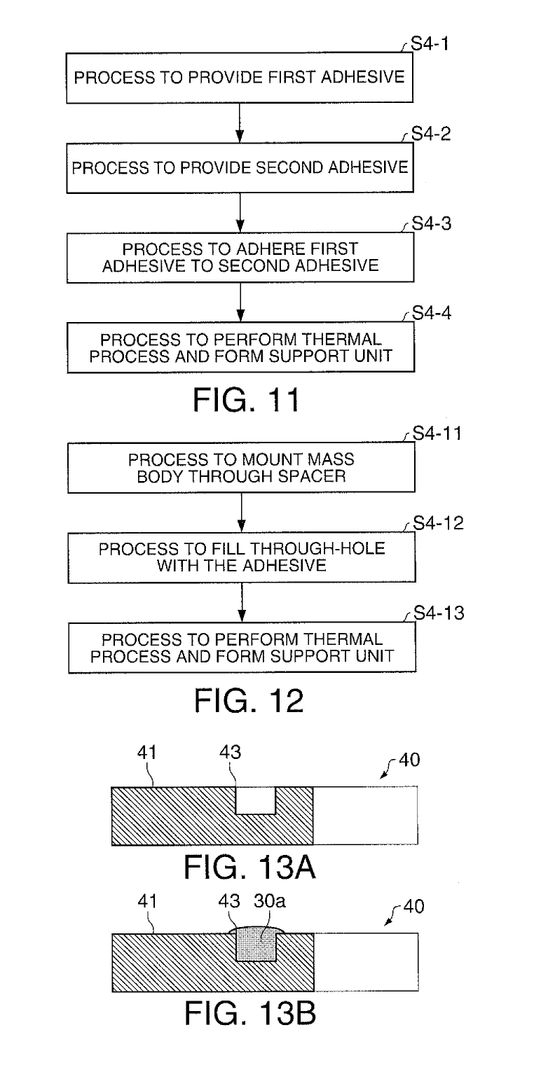

As shown in FIG. 11, the process S4 to form the support unit may include a process (S4-1) to provide the first adhesive 30a on the first opening part 43 of the mass body 40, a process (S4-2) to provide the second adhesive 30b on at least one of both the main surfaces of the movable body 14, a process (S4-3) to adhere the first adhesive 30a to the second adhesive 30b, and a process (S4-4) to form the support unit 30 by performs a thermal process.

Otherwise, when the mass body 40 includes the through-hole 48, the process (S4) to form the support unit 30 may include a process (S4-11) to mount the mass body 40 on at least one of both the main surfaces of the movable body 14 through spacers 60 such that the second opening 46 faces the outside and the first opening part 43 faces the side of the movable body 14, a process (S4-12) to inject the adhesive 30d from the side of the second opening 46 and to fills the through-hole 48 of the mass body 40 with the adhesive 30d, and a process (S4-13) to form the support unit 30 which supports the mass body 40 by performing the thermal process, as shown in FIG. 12.

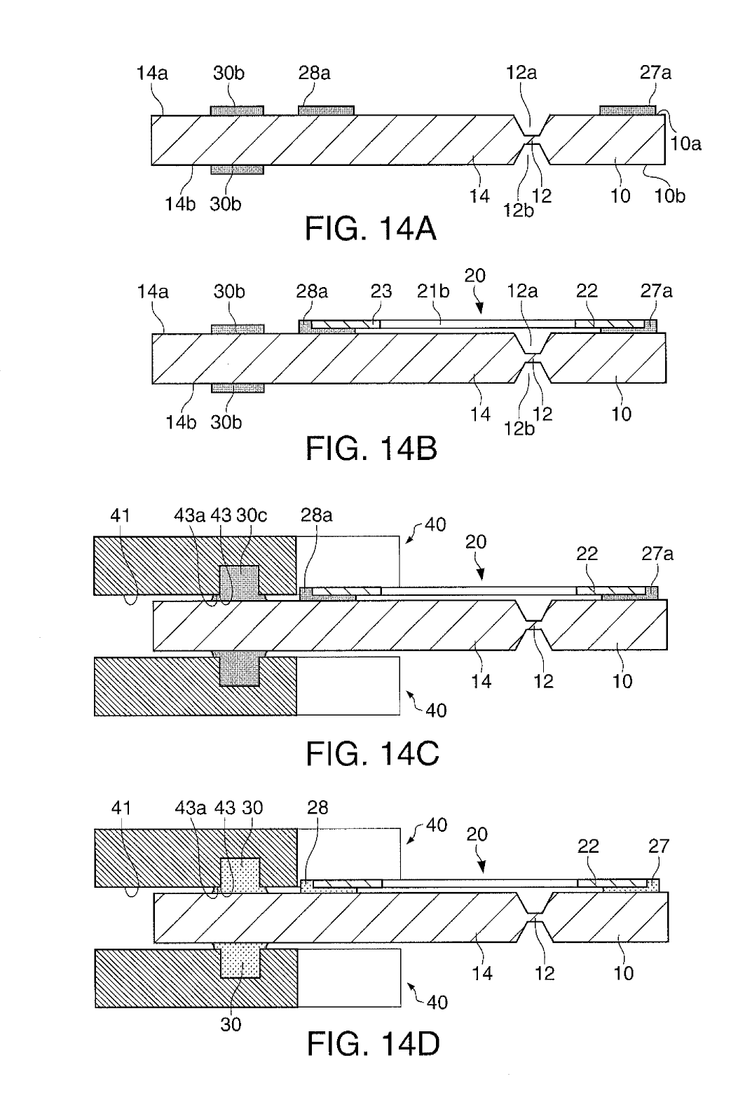

First, a manufacturing method of a physical quantity detection device in a case in which the through-hole 48 is not formed in the mass body 40 and the first opening part 43 has a depressed portion shape will be described with reference to FIGS. 13A to 14D.

As shown in FIG. 13A, the first opening part 43 which does not pass through the mass body 40 is formed on the first surface 41 of the mass body 40 using well-known physical or chemical means. With regard to grinding means, for example, a grinding apparatus, which uses a sandblasting device, a drill, air, laser, or the like, and wet and dry etching devices can be used. It is possible to cause the inner wall surface to be a rough surface by using a machine tool, such as a sandblasting device, a drill, or the like, as the grinding means.

As shown in FIG. 13B, first adhesive 30a is provided on the first opening part 43 of the mass body 40 in advance using a dispenser or the like before the first opening part 43 of the mass body 40 is mounted on the movable body 14. The first adhesive 30a maintains an uncured state. Therefore, it is possible to reliably fill the inside of the first opening part 43 with the first adhesive 30a.

Subsequently, as shown in FIG. 14A, the base 10 and the movable body 14 are prepared. When a crystal substrate is formed, the coupling part 12 or the like is formed by patterning the crystal substrate using, for example, a photolithography technology or an etching technology. Therefore, it is possible to prepare the base 10 and the movable body 14 which is provided through the coupling part 12.

Here, although not shown in the drawing, it is possible to form a conductive layer, such as a connection terminal 56a, on the base 10 and the movable body 14. The conductive layer is formed in such a way that a film of the conductive layer is formed using, for example, a sputtering method or a Chemical Vapor Deposition (CVD) method, and then patterned using a photolithography technology or an etching technology.

The second adhesive 30b is provided in a region in which the support unit 30 of the movable body 14 is formed. The second adhesive 30b is an adhesive which is formed of a material which is the same as that of the first adhesive 30a.

In addition, in a region in which the physical quantity detection element 20 of the base 10 and the movable body 14 is provided, the bonding members 27a and 28a are provided to support the physical quantity detection element 20. For example, low melting point glass, Au/Sn alloy coat, which can be used for eutectic bonding, may be used as the bonding members 27a and 28a, or resin adhesive material may be used. Here, when the bonding members 27a and 28a and the second adhesive 30b are formed of the same material, it is possible to plan to reduce a manufacturing process.

Subsequently, as shown in FIG. 14B, the physical quantity detection element 20 is provided to be laid between the base 10 and the movable body 14. It is possible to support the physical quantity detection element 20 by mounting the physical quantity detection element 20 on the bonding members 27a and 28a.

Subsequently, as shown in FIG. 14C, the prepared mass body 40 is mounted on the movable body 14. Here, the first adhesive 30a adheres to the second adhesive 30b, and thus an uncured support unit 30c is formed. Subsequently, as shown in FIG. 14D, it is possible to form the support unit 30 by performing a thermal process under a desired temperature condition. In addition, in the thermal process, the bonding members 27a and 28a may be hardened at the same time.

As described above, the process (S4-1) to provide the first adhesive 30a, the process (S4-2) to provide the second adhesive 30b, the process (S4-3) to adhere the first adhesive 30a to the second adhesive 30b, and the process (S4-4) to form the support unit 30 by performing the thermal process are included. Therefore, a position alignment process of the mass body 40 becomes simple, and, in addition, it is possible to reliably prevent the amount of adhesive used to form the support unit 30 from being insufficient.

Subsequently, the manufacturing method of a physical quantity detection device in a case in which the through-hole 48 is formed in the mass body 40 will be described with reference to FIGS. 12 to 15D.

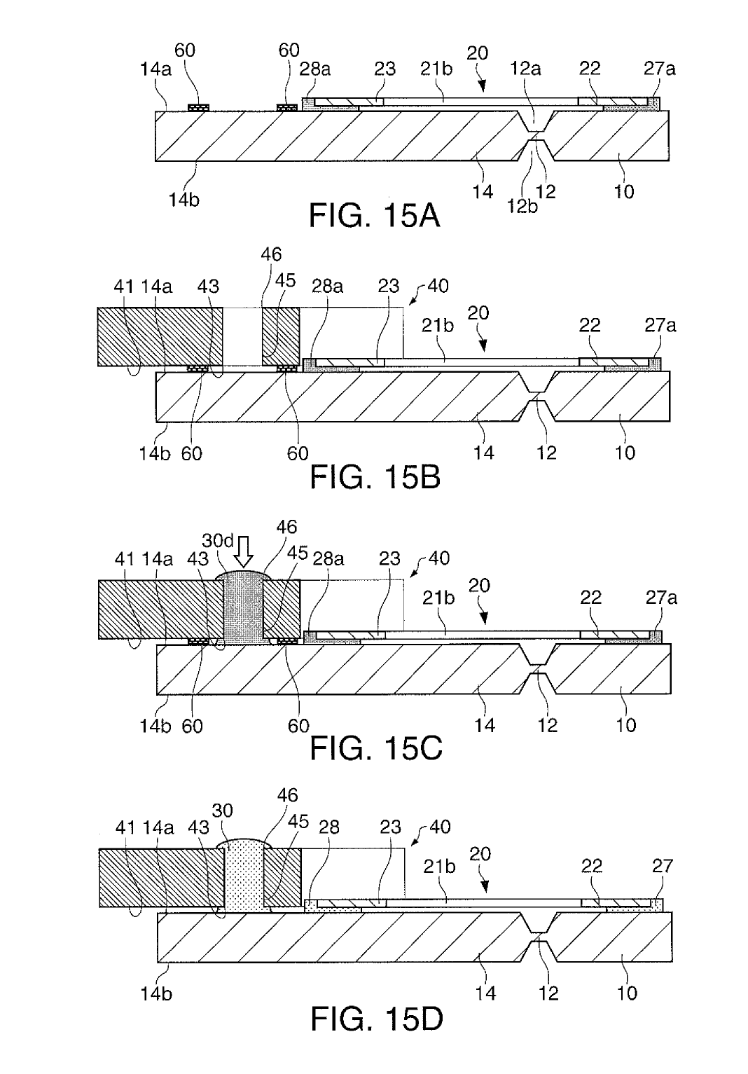

As shown in FIG. 15A, in the process to form the support unit 30, a spacer 60 having desired thickness is first mounted on the movable body 14. The spacer 60 has a shape which provides a desired space in a region in which the support unit 30 is provided.

Subsequently, as shown in FIGS. 15B and 15C, the mass body 40 is mounted on the spacer 60, and adhesive 30d is injected from the side of the second opening 46. Therefore, it is possible to uncured support unit 30d which is formed on the movable body 14, and fills the through-hole 48. Subsequently, as shown in FIG. 15D, it is possible to form the support unit 30 which fills the through-hole 48 by performing the thermal process under the desired temperature condition. It is possible to appropriately remove the spacer 60 after the support unit 30 is formed.

As described above, the process (S4-11) to mount the mass body 40 through the spacer 60, the processes (S4-12, S4-13) to fill the through-hole 48 of the mass body 40 with the adhesive and form the support unit 30 which supports the mass body 40 by performing the thermal process are included. Therefore, it is convenient to adjust the height of the mass body 40, and it is possible to arrange the mass body 40 with high alignment accuracy. In other words, it is possible to simply adjust the gap between the mass body 40 and the movable body 14 by adjusting the thickness of the spacer 60. In addition, it is possible to fill the inside of the through-hole 48 with the support unit 30 using a simple method. Therefore, it is possible to provide the physical quantity detection device, in which the bonding reliability of the mass body is further improved, using a simple method.

The manufacturing method of a physical quantity detection device according to the embodiment has, for example, the following characteristics.

According to the manufacturing method of a physical quantity detection device, the process to prepare the mass body 40 having the first opening part 43, and a process to form the support unit 30 which is provided on at least one of both the main surfaces of the movable body 14, and supports the mass body 40 by filling the inside of the first opening part 43 are included. Therefore, it is possible to simply manufacture the physical quantity detection device in which the bonding reliability of the mass body 40 is improved.

### 3. PHYSICAL QUANTITY DETECTOR

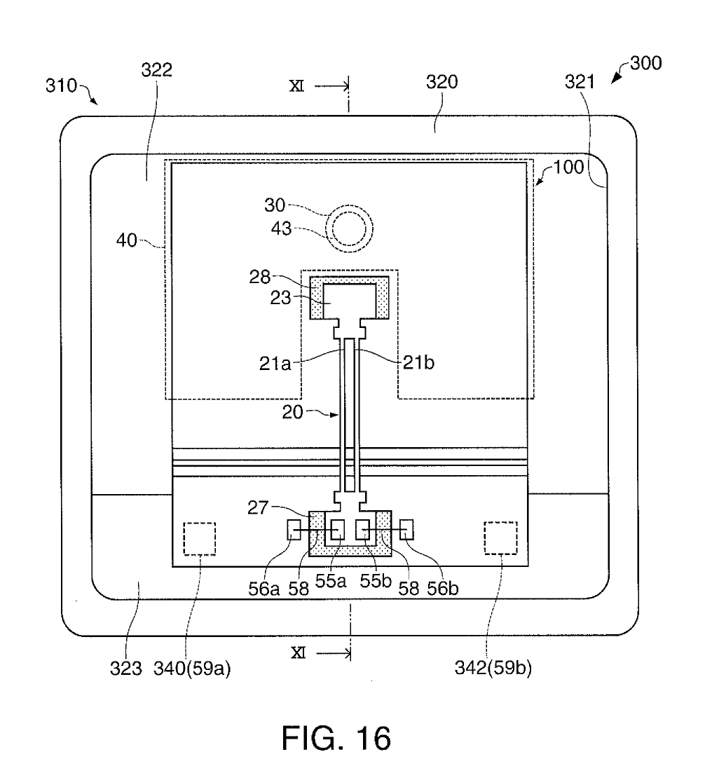

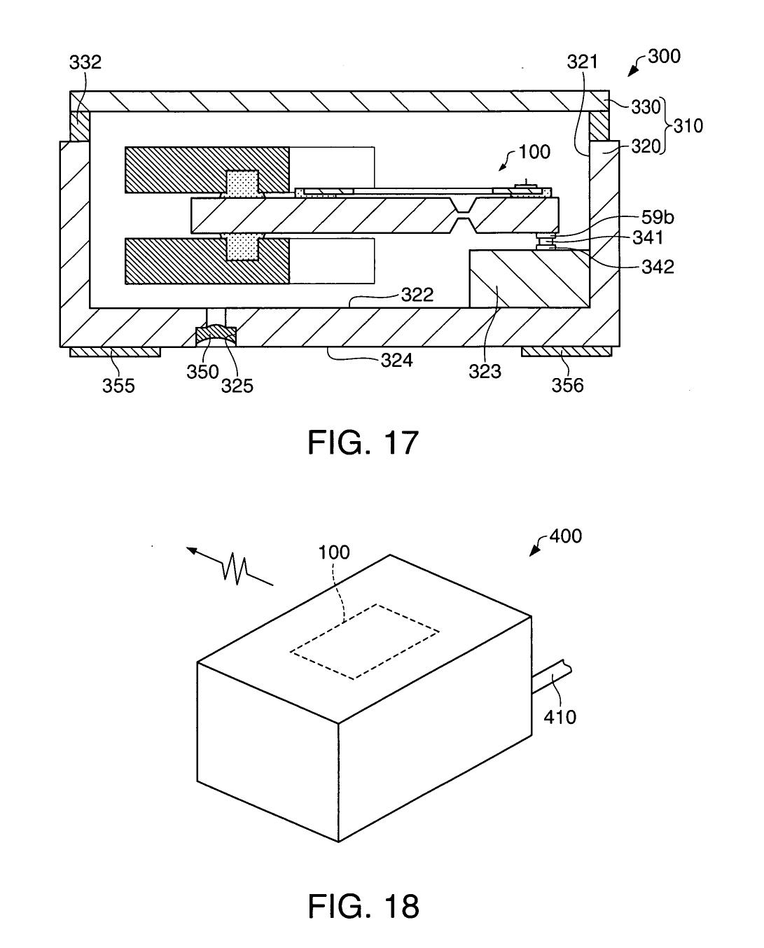

Subsequently, a physical quantity detector according to the embodiment will be described with reference to the drawings. FIG. 16 is a plan view schematically illustrating a physical quantity detector 300 according to the embodiment. FIG. 17 is a cross-sectional view schematically illustrating the physical quantity detector 300 according to the embodiment. Meanwhile, FIG. 17 is a cross-sectional view taken along line XI-XI of FIG. 16.

The physical quantity detector 300 includes the physical quantity detection device according to the embodiment of the invention and a package 310, as shown in FIGS. 16 and 17. Hereinafter, an example in which the physical quantity detection device 100 is used as the physical quantity detection device according to the embodiment of the invention will be described.

The package 310 contains the physical quantity detection device 100. The package 310 can include a package base 320 and a lid 330. Meanwhile, in FIG. 16, the lid 330 is not shown in the drawing for convenience.

A depressed portion 321 is formed in the package base 320, and the physical quantity detection device 100 is arranged in the depressed portion 321. The planar shape of the package base 320 is not particularly limited if it is possible to arrange the physical quantity detection device 100 in the depressed portion 321. For example, a material, such as aluminum oxide quality sintering body which is obtained in such a way that a ceramic green sheet is formed, laminated, and burned, crystal, glass, silicon, or the like, is used as the package base 320.

The package base 320 can include a step section 323 which protrudes toward the side of the lid 330 from the bottom surface (the bottom surface of the depressed portion) 322 in the package base 320. The step section 323 is provided along, for example, the inner wall of the depressed portion 321. In the step section 323, inner terminals 340 and 342 are provided.

The inner terminals 340 and 342 are provided, for example, at positions (overlapping positions in a planar view) which face external connection terminals 59a and 59b provided in the physical quantity detection device 100. For example, the external connection terminal 59a is electrically connected to the inner terminal 340, and the external connection terminal 59b is electrically connected to the inner terminal 342.

External terminals 355 and 356, which are used when being mounted in the external member, are provided on the external bottom surface 324 (a surface which is opposite to the inner bottom surface 322) of the package base 320. The external terminals 355 and 356 are electrically connected to the inner terminals 340 and 342 through inside wiring which is not shown in the drawing. For example, the external terminal 355 is electrically connected to the inner terminal 340, and the external terminal 356 is electrically connected to the inner terminal 342.

The inner terminals 340 and 342 and the external terminals 355 and 356 are formed of, for example, a metallic film in which a film formed of Ni, Au, or the like is layered on a metallization layer formed of W through plating.

A sealing section 350, which seals the inside (cavity) of the package 310 at the bottom of the depressed portion 321, is provided in the package base 320. The sealing section 350 is arranged in the through-hole 325 which is formed in the package base 320. The through-hole 325 passes from the outside bottom surface 324 to the inside bottom surface 322. In the example shown in the drawing, the through-hole 325 has a stepped shape in which the internal diameter on the side of the outside bottom surface 324 is greater than the internal diameter on the side of the inside bottom surface 322. The sealing section 350 is formed in such a way that a sealing material formed of, for example, Au/Ge alloy, solder, or the like is arranged in the through-hole 325, melted by heat, and then solidified. The sealing section 350 is configured to seal the inside of the package 310 to be airproof.

The physical quantity detection device 100 is fixed to the step section 323 of the package base 320 through the bonding member 341. Therefore, the physical quantity detection device 100 is mounted on the package base 320, and contained in the package 310.

When the physical quantity detection device 100 is fixed to the step section 323, the external connection terminals 59a and 59b, which are provided in the physical quantity detection device 100, are electrically connected to the inner terminals 340 and 342, which are provided in the step section 323, through the bonding member 341. It is possible to use, for example, silicon resin series conductive adhesive, with which a conductive material such as metal filler is mixed, as the bonding member 341.

The lid 330 is provided to cover the depressed portion 321 of the package base 320. The shape of the lid 330 is, for example, a plate. For example, a material which is the same as the package base 320 or metal, such as kovar, 42 alloy, stainless steel, or the like, is used as the lid 330. The lid 330 is bonded to the package base 320 through, for example, the bonding member 332 such as seamless, low melting point glass, adhesive, or the like.

After the lid 330 is bonded to the package base 320, the sealing material is arranged in the through-hole 325 in a state in which the pressure of the inside of the package 310 is reduced (in a state in which the degree of vacuum is high), melted by heat, and then solidified, and thus the sealing section 350 is formed. Therefore, it is possible to seal the inside of the package 310 to be airproof. The inside of the package 310 may be filled with inert gas, such as nitrogen, helium, argon, or the like.

In the physical quantity detector 300, if the driving signal is input to the excitation electrodes of the physical quantity detection element 20 through the external terminals 355 and 356, the inner terminals 340 and 342, the external connection terminals 59a and 59b, or the connection terminals 56a and 56b, the vibrating beam parts 21a and 21b of the physical quantity detection element 20 vibrate (resonate) at a predetermined frequency. Further, the physical quantity detector 300 can output the resonance frequency of the physical quantity detection element 20 which varies depending on applied acceleration as an output signal.

According to the physical quantity detector 300, the physical quantity detection device 100 in which the bonding reliability of the mass body is improved is included. Therefore, the physical quantity detector 300 can provide the physical quantity detector in which reliability is improved.

Meanwhile, although not shown in the drawing, the depressed portion in which the physical quantity detection device 100 is arranged may be formed on both the package base 320 and the lid 330, and may be formed on only the lid 330.

### 4. ELECTRONIC APPARATUS

Subsequently, an electronic apparatus according to the embodiment will be described. Hereinafter, as the electronic apparatus according to the embodiment, an inclinometer which includes a physical detection device (in an example hereinafter, referred to as a physical quantity detection device 100) according to the embodiment of the invention will be described with reference to the accompanying drawing. FIG. 18 is a perspective view schematically illustrating an inclinometer 400 according to the embodiment.

The inclinometer 400 includes the physical quantity detection device 100 as an inclination sensor, as shown in FIG. 18.

The inclinometer 400 is installed in a measured location such as, for example, a mountainside, the slope on the road, the retaining wall of the earth, or the like. Power is supplied to the inclinometer 400 from the outside through a cable 410, or power is built therein, and thus a driving signal is transmitted to the physical quantity detection device 100 by a driving circuit which is not shown in the drawing.

Further, the inclinometer 400 detects variation in the posture of the inclinometer 400 (variation in the direction in which the gravity acceleration is added to the inclinometer 400) based on the resonance frequency which changes depending on the gravity acceleration added to the physical quantity detection device 100 using a detection circuit which is not shown in the drawing, converts the variation into an angle, and transmits data to a base station, for example, in wireless. Therefore, the inclinometer 400 can contribute to the early detection of abnormality.

According to the inclinometer 400, the physical quantity detection device 100 which improves the bonding reliability of the mass body is included. Therefore, the inclinometer 400 can provide an inclinometer which improves the reliability.

The physical quantity detection device according to the invention is not limited to the above-described inclinometer, and can be properly used as the acceleration sensor or the inclination sensor of a seismograph, a navigation apparatus, a posture control apparatus, a game controller, a mobile phone, or the like. In any case, it is possible to provide an electronic apparatus which has advantages which have been described in the embodiment and the modification examples.

The invention includes substantially the same configuration as the configuration which has been described in the embodiment (for example, a configuration having the same function, method, and results, or a configuration having the same object and advantage). In addition, the invention includes a configuration which replaces a section which is not essential in the configuration which has been described in the embodiment. In addition, the invention includes a configuration which has the same advantage as that of the configuration which has been described in the embodiment, and a configuration which enables the same object to be accomplished. In addition, the invention includes a configuration which adds a well-known technology to the configuration which has been described in the embodiment.

The entire disclosure of Japanese Patent Application No. 2012-085865, filed Apr. 4, 2012 is expressly incorporated by reference herein.

What is claimed is:

1. A physical quantity detection device comprising:
a base;
a movable body that is supported by the base, and is displaced depending on a physical quantity;
a physical quantity detection element that is laid between the base and the movable body;
a support unit that is arranged above at least one side of both main surfaces of the movable body; and
a mass body that includes a first opening part, and is supported by the support unit in such a way that an inside of the first opening part is filled with the support unit.

2. The physical quantity detection device according to claim 1,
wherein the support unit is arranged to be extended to a circumference of an opening of the first opening part of the mass body.

3. The physical quantity detection device according to claim 1,
wherein the first opening part includes:
a first section that has a first internal diameter; and
a second section that is further separated from the movable body than the first section, continues on the first section, and has a second internal diameter which is greater than the first internal diameter.

4. The physical quantity detection device according to claim 1,
wherein the first opening part has a taper-shaped inner wall surface.

5. The physical quantity detection device according to claim 1,
wherein the first opening part is a through-hole which communicates with the second opening.

6. The physical quantity detection device according to claim 5,
wherein the support unit is arranged to be extended to the circumference of the second opening.

7. The physical quantity detection device according to claim 1,
wherein an inner wall surface of the first opening part of the mass body is a rough surface.

8. A manufacturing method of a physical quantity detection device comprising:
preparing a base and a movable body that is supported by the base and is displaced depending on a physical quantity;
providing a physical quantity detection element that is laid between the base and the movable body;
preparing a mass body that includes a first opening part;
in a state in which insides of the first opening part are filled with a support unit, supporting the mass body by the movable body through the support unit in such a way that an opening of the first opening part on at least one side of both main surfaces of the movable body faces to another.

9. The manufacturing method of a physical quantity detection device according to claim 8,
wherein the forming of the support unit includes:
arranging a first adhesive in the first opening part of the mass body;
arranging a second adhesive in at least one side of both main surfaces of the movable body; and
forming the support unit by performing a thermal process after bonding the first adhesive to the second adhesive.

10. The manufacturing method of a physical quantity detection device according to claim 8,
wherein the first opening part of the mass body is a through-hole which communicates with the second opening,
wherein the forming of the support unit includes:
mounting the mass body on at least one side of both the main surfaces of the movable body through a spacer such that the second opening faces an outside and the first opening part faces a side of the movable body; and
injecting adhesive from a side of the second opening, filling the through-hole of the mass body with the adhesive, and forming the support unit that supports the mass body by performing the thermal process.

11. The physical quantity detection device according to claim 1,
wherein the physical quantity detection element is a twin-tuning fork vibrating element.

12. A physical quantity detector comprising:
the physical quantity detection device according to claim 1; and
a package that contains the physical quantity detection device.

13. A physical quantity detector comprising:
the physical quantity detection device according to claim 2; and
a package that contains the physical quantity detection device.

14. An electronic apparatus comprising:
the physical quantity detection device according to claim 1.

15. An electronic apparatus comprising:
the physical quantity detection device according to claim 2.
